(19) United States
(12) Patent Application Publication
(10) Pub. No.: US 2005/0123293 A1
(43) Pub. Date: Jun. 9, 2005

(54) Optical transmission method and system

(75) Inventors: Kazumitsu Maki, Kawasaki (JP); Haruo Yamashita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/039,916

(22) Filed: Jan. 24, 2005

Related U.S. Application Data
(63) Continuation of application No. PCT/JP02/07427, filed on Jul. 23, 2002.

(51) Int. Cl. H04B 10/08

(52) U.S. Cl. 398/12

(57) ABSTRACT

In an optical transmission method and system for performing a bidirectional optical transmission at an identical wavelength between an intra-office transmission circuit and in-house transmission circuits with a single-core optical fiber, the intra-office transmission circuit detects, based on a response failure of the in-house transmission circuits, an in-house transmission circuit corresponding to the response failure, and further detects a failure point by transmitting an optical isolated pulse to the in-house transmission circuit corresponding to the response failure in order to automatically detect a disconnection failure of an optical fiber without connecting a specific measuring device.

### BACKGROUND OF THE INVENTION

1. Field of the Invention

The present invention relates to an optical transmission system, and in particular to a same (identical or homo-) wavelength bidirectional optical transmission method and system with a single-core optical fiber.

2. Description of the Related Art

For performing a bidirectional transmission in an optical transmission system, up/down directional transmissions have been generally performed with two-core optical fibers. In order to increase a transmission capacity of an optical fiber, a WDM (Wavelength Division Multiplexing) transmission has been occasionally performed for each up/down direction.

On the other hand, in an access system connecting an office (intra-office) of a carrier and a user's house (in-house), the number of accesses is large. Therefore, it would be economical if a bidirectional transmission can be performed with a single-core optical fiber. As for the single-core bidirectional optical transmission system, there is a WDM bidirectional transmission system with an individual wavelength for each up/down direction. However, there is an economical limit since light-emitting devices with different wavelengths have to be prepared, a wavelength dependence has to be provided to an add/drop device and the like. Also, since wavelengths are valuable resources like radio waves, it is desirable to transmit a single service with a single wavelength bidirectionally.

As the identical wavelength single-core bidirectional transmission system, there are a time compression multiplexing-bidirectional optical transmission system and an echo canceller-bidirectional optical transmission system, and both principles thereof are the same as that of a metallic transmission.

Single-core Identical Wavelength Bidirectional Transmission System (one-to-one connection: see FIG. 7)

Operations of the former single-core identical wavelength time compression multiplexing-bidirectional optical transmission system will now be described referring to FIG. 7. It is to be noted that since a principle of a time compression multiplexing-bidirectional transmission system is described in detail in a document “multimedia network series: digital access system” (Ohmsha) and the like, the description thereof will be herein omitted.

Firstly, an intra-office transmission circuit 1 and an in-house transmission circuit 2 are opposed through an optical fiber 30. Information transmitted from the intra-office transmission circuit 1 to the in-house transmission circuit 2 is time-compressed by an intra-office transmission logical circuit portion 11, and is converted into an optical pulse by an intra-office electro-optic converting circuit portion 12 to be transmitted to the optical fiber 30 through an intra-office optical coupler 13.

In the in-house transmission circuit 2, the optical pulse received from the optical fiber 30 through an in-house optical coupler 23 is returned to an electric signal by an in-house opto-electric converting circuit portion 24, and is further time-decompressed by an in-house reception logical circuit portion 25 to take out information of an original rate.

Similarly in the information transmission in the reverse direction from the in-house transmission circuit 2 to the intra-office transmission circuit 1, the information is time-compressed by an in-house transmission logical circuit portion 21, and is converted into the optical pulse by an in-house electro-optic converting circuit portion 22 to be transmitted to the optical fiber 30 through the in-house optical coupler 23. In the intra-office transmission circuit 1, the optical pulse received from the optical fiber 30 through the intra-office optical coupler 13 is returned to the electric signal by an intra-office opto-electric converting circuit portion 14, and is time-decompressed by an intra-office reception logical circuit portion 15 to take out information of the original rate.

Also, an intra-office control circuit portion 16 generates a control signal or the like required for a time operation from an intra-office clock pulse. Also, an in-house control circuit portion 26 extracts clock information required for the time operation from a pulse train received to generate a required control signal or the like.

The transfer of a transmission signal between the intra-office transmission circuit 1 and the in-house transmission circuit 2 during a normal operation will now be described referring to FIG. 8.

Firstly, a down burst signal 1112 transmitted from the intra-office transmission circuit 1 undergoes an attenuation due to a loss and a transmission delay time (Tps) within the optical fiber 30 to be received by the in-house transmission circuit 2. After having received the down burst signal 1112, the in-house transmission circuit 2 transmits an up burst signal 1114 after a protection time (Tg) for preventing interference between up and down transmissions. The up burst signal 1114 undergoes an attenuation due to a loss and a transmission delay time (Tpr) within the optical fiber 30 to be received by the intra-office transmission circuit 1.

An occupation time (Tis) of the down burst signal 1112 and an occupation time (Tir) of the up burst signal are equal. Also, the down transmission delay time (Tps) and the up transmission delay time (Tpr) are equal. The sum of the occupation times (Tis and Tir) of the up/down burst signals, the up/down transmission delay times (Tps and Tpr) and the protection time (Tg) assumes a burst cycle time (Tb).

Echo Canceller-bidirectional Optical Transmission System (one-to-one Connection: FIG. 9)

The latter echo canceller-bidirectional optical transmission system will now be described referring to FIG. 9.

In this echo canceller-bidirectional optical transmission system, the intra-office transmission circuit 1 in FIG. 7 has an intra-office echo canceller circuit portion 17 and an intra-office subtractor 18. The in-house transmission circuit 2 has an in-house echo canceller portion 27 and an in-house subtractor 28.

It is to be noted that since the principle of the echo canceller bidirectional transmission system is also described in detail in the above-mentioned document “multimedia network series: digital access system” (Ohmsha), the description thereof will be herein omitted.

Firstly, the intra-office transmission circuit 1 and the in-house transmission circuit 2 are opposed through the optical fiber 30. A frame synchronization signal or the like is added to information transmitted from the intra-office transmission circuit to the in-house transmission circuit by the intra-office transmission logical circuit portion 11, so that the information becomes an optical pulse by the intra-office electro-optic converting circuit portion 12 to be transmitted to the optical fiber 30 through the intra-office optical coupler 13. In the in-house transmission circuit, the received optical pulse is led to the in-house opto-electric converting circuit portion 24 through the in-house optical coupler 23, and the processing of the frame synchronization signal is performed by the in-house reception logical circuit portion 25, so that original information is taken out.

Also in the information transmission in the reverse direction from the in-house transmission circuit to the intra-office transmission circuit, the frame synchronization signal or the like is added to the information by the in-house transmission logical circuit portion 21, and becomes an optical pulse by the in-house electro-optic converting circuit portion 22 to be transmitted to the optical fiber 30 through the in-house optical coupler 23. In the intra-office transmission circuit, the received optical pulse is led to the intra-office opto-electric converting circuit portion 14 from the optical fiber 30 through the intra-office optical coupler 13, and the processing of the frame synchronization signal is performed by the intra-office reception logical circuit portion 15, so that original information is taken out.

The above-mentioned operation is the same as that of the time compression multiplexing-bidirectional optical transmission system shown in FIG. 7. However, the echo canceller-bidirectional optical transmission system is different from the time compression multiplexing-bidirectional optical transmission system in that up/down transmission signals coexist sequentially and synchronously in the optical fiber 30 during information transfer.

The operation of the echo canceller system will now be described referring to FIG. 10. The intra-office echo canceller 17 performs a training at a start of communication. A training signal 3112 from the intra-office transmission logical circuit portion 11 is transmitted as an optical signal 3113 to the optical fiber 30 through the intra-office optical coupler 13.

The sum of a reflection signal 3114 of the training signal 3113 transmitted to the optical fiber 30 and a training signal 3115 having leaked at the intra-office optical coupler 13 is inputted to the intra-office opto-electric converting circuit portion 14 to be converted into the electric signal.

The intra-office echo canceller 17, based on this intra-office training signal 3112, sets its own operation parameter so as to generate a signal (referred to as an echo signal) canceling the sum signal of the leaking signal 3115 to the reception side and the reflection signal 3114 from the optical fiber.

During a normal operation, the up/down transmission signals sequentially and synchronously flow in the optical fiber 30. However, at the intra-office subtractor 18, the reception signal from the in-house transmission circuit and the leaking signal from the intra-office transmission signal are added from the intra-office opto-electric converting circuit portion 14, and the echo signal is added from the intra-office echo canceller 17. As a result, the output signal of the intra-office subtractor 18 is only the reception signal from the in-house transmission circuit to be transmitted to the intra-office reception logical circuit portion 15. Since the operation of the echo canceller in the in-house transmission circuit is the same, the description will be herein omitted.

The intra-office control circuit portion 16 generates a necessary control signal such as the frame synchronization signal from an intra-office clock SCK. Also, the in-house control circuit portion 26 extracts the information of the frame synchronization signal or the like from the pulse train received to generate a necessary control signal. It is to be noted that in the echo canceller-bidirectional optical transmission system, there is a maximum applied distance (Lmax) as a system from a limitation due to the loss of the optical fiber. This will be described later.

Since the up/down signals are separated temporally in the former time compression multiplexing-bidirectional optical transmission system, the optical coupler may be simple. However, a transmission signal rate is required to be more than twice as fast as the information rate.

Also, the transmission signal rate and the information rate are almost the same in the latter echo canceller-bidirectional optical transmission system. However, a directional coupler is required to be used for the optical coupler in order to improve the separation of the up/down signals.

Single-core Identical Wavelength Time Compression

Multiplexing-bidirectional Optical Transmission System (one-to-many Connection: FIG. 11)

The time compression multiplexing-bidirectional optical transmission system as the above-mentioned identical wavelength single-core bidirectional transmission system is applied to a single-core identical wavelength one-to-many connection type optical branch-bidirectional optical transmission system which is economical by sharing an optical fiber and an information bandwidth by a plurality of users with an optical branch device.

Operations of the single-core identical wavelength one-to-many connection type optical branch-bidirectional optical transmission system will now be described referring to FIG. 11. It is to be noted that the above-mentioned echo canceller-bidirectional optical transmission system is not applied to this transmission system.

This single-core identical wavelength one-to-many connection type optical branch-bidirectional optical transmission system is a kind of an optical transmission system called a PON (Passive Optical Network) system. Since the PON system is described in detail in e.g. a document “xDSL/FTTH” (Ascii Press), the description thereof will be herein omitted.

In the single-core identical wavelength one-to-many connection type optical branch-bidirectional optical transmission system, an Optical Line Termination circuit (hereinafter, abbreviated as OLT) 101 corresponding to the above-mentioned intra-office transmission circuit 1 and an Optical Network Unit (hereinafter, abbreviated as ONU) 201 corresponding to the in-house transmission circuit 2 are connected in a 1:N relationship through an optical branch device 300. “N” is an integer indicating the number of connected ONUs.

Transmission information is accommodated within a predetermined time slot, and a control byte required for the communication as the PON system which performs a one-to-many connection type optical branch-bidirectional optical transmission is added as required to be transferred. In the down direction from the OLT 101 to ONUs 201#1-201#N (hereinafter, occasionally represented by a reference numeral 201), information time slots addressed to the ONUs .201 are multiplexed and sequentially transferred. Each ONU 201 extracts only the information time slot addressed to itself
On the other hand, in the up direction from each ONU 201 to the OLT 101, the information time slot is transferred per a predetermined time slot instructed by the OLT 101. Namely, as shown in FIG. 12, in the burst cycle Tb, an optical pulse 2112 for measuring a delay time is transmitted from the intra-office OLT 101 to a newly established in-house ONU 2011 with a time until a down direction burst signal 1112 is returned through the intra-office OLT 101→in-house ONU 201→intra-office OLT 101 being made an overall ONU operation guarantee window Tw. Thus, a delay time Ta specific to the in-house ONU 2011 is previously measured. A time slot Ts1 is allocated to an already established ONU 2012, and a time slot Ts2 is allocated to the newly established ONU 2011, so that the transmission of the burst signal is performed.

As mentioned above, when the ONU 2011 is newly established during the operation of the already established ONU 2012, the pulse train 2112 for measuring delay time including information “time slot-unallocated ONU is requested to respond” is broadcast within the overall ONU operation guarantee window Tw from the intra-office OLT 101. Upon receiving the pulse train 2112, the newly established ONU 2011 returns a response pulse train 2114 including its own ID information.

Upon receiving the response from the newly established ONU 2011, the intra-office OLT 101 measures a delay time Ta, and transmits frame information F including a designated time slot and a delay adjustment time Td therein to the newly established ONU 2011.

It is possible to insert the pulse train 2112 for measuring delay time into every burst cycle, once in several seconds or by instructions from outside when an ONU is newly established.

The newly established ONU 2011 reads the time slot position Ts2 of its own and the delay adjustment time Td from the frame information F in the head of the burst signal from the intra-office OLT 101, and receives only information of the designated time slot Ts2 from an information train broadcast from the intra-office OLT 101.

Also, the newly established ONU 2011 identifies a transmission timing to the intra-office OLT 101 from the protection time Tg (fixed value), the delay adjustment time Td depending on the distance between the ONU and the OLT, and a time slot position designated time Tt depending on each ONU, and transmits information to the designated time slot Ts2.

In the optical bidirectional transmission, an optical signal is compressed on a time axis in the up/down direction to be transferred.

Operations of the time compression and decompression in the transmissions of information from the intra-office OLT to the in-house ONU and information from the in-house ONU to the intra-office OLT in the reverse direction are performed as shown in FIG. 13.

Namely, the bit stream of the transmission information of the intra-office OLT 101 is time-compressed at every burst cycle (Tb), and is put in e.g. the time slot Ts1 within the signal 1112 to be transmitted to the in-house ONU 201. The time-compressed bit stream of the time slot Ts1 is time-decompressed by the in-house ONU 201 to be returned to information of the original rate, which is made a bit stream of in-house reception information.

As a result, the intra-office information at a bit stream position A (see arrow) of FIG. 13 is reproduced at a bit stream position A′ (see arrow) of the in-house information.

The difference between the single-core time compression multiplexing-bidirectional optical transmission system and the one-to-many connection type optical branch-bidirectional optical transmission system by the PON system is that a TDMA (Time Domain Multiple Access) control is performed so as not to break information by a collision of the up information from each ONU 201 connected at the intra-office optical branch device.

The information time slots Ts1 and Ts2 (see FIG. 12) from the ONUs 2012 and 2011 (see FIG. 12) to the OLT 101 are transmitted at a predetermined timing based on the transmission delay time instructions from the OLT 101, so that the information time slots Ts1 and Ts2 from the ONUs 2012 and 2011 are identified by the OLT 101.

The operations in FIGS. 12 and 13 will be further described referring to FIG. 14.

The down burst signal 1112 transmitted from the intra-office OLT 101 is data including an information time slot addressed to each ONU 201, and undergoes an attenuation due to a loss and the propagation delay time (Tps) within the optical fiber to be received by e.g. the in-house ONU #k.

The attenuation and the propagation delay time of the data received by each ONU 201 at this time depend on a distance from the OLT 101. The in-house ONU 201 extracts the information time slot addressed to the concerned ONU #k from the down burst signal 1112. After having received the information time slot, the in-house ONU 201 transmits the information to a time slot Ts#k within a time zone of the up burst signal 1114 instructed by the OLT 101 after having put the information on standby for a time of the protection time (Tg) for preventing an interference between the up and down transmissions plus the delay adjustment time (Td) for preventing the collision of the up information from each ONU 201. This up burst signal 1114 undergoes an attenuation due to a loss and the propagation delay time (Tpr) within the optical fiber 30 to be received at the intra-office OLT.

The up burst signal 1114 received by the OLT 101 is an aggregation of information time slots transmitted from the ONUs 201. In this case, the occupation time (Tis) of the down burst signal 1112 and the occupation time (Tir) of the up burst signal are equal. Also, the down propagation delay time (Tps) and the up propagation delay time (Tpr) are equal at each ONU 201. However, since the ONUs 201 are different from each other in the distances from the OLT 101, the values of the ONUs 201 are also different from each other.

The sum of the occupation times of the up/down burst signals, the up/down propagation delay times, the protection time and the delay adjustment time assumes the burst cycle time (Tb).

It is to be noted that in the single-core identical wavelength one-to-many connection type optical branch-bidirectional optical transmission system, there is the maximum applied distance (Lmax) as a system. This maximum distance is used for determining a delay time by which each ONU 201 is adjusted so as to be logically located at the same distance from the OLT 101.

Namely, each ONU 201 adjusts the delay time of the information time slot transmitted so that all of the ONUs 201 are located at the position of the Lmax as a logical distance, in order to prevent the collision of the up burst signal 1114 from each ONU 201 and guarantee the entire ONU operation.

The mechanism of the delay time adjustment will now be described referring to FIG. 15, where two in-house ONUs, an in-house ONU #j and the ONU #k are connected. The intra-office OLT 101 measures the transmission distance to each in-house ONU 201, and notifies, based on the result thereof, the delay adjustment time to each in-house ONU 201 from the intra-office OLT 101.

At this time, a delay adjustment time Tdi for the in-house ONU #i is determined so that the relationship indicated by the following equation may be held between a propagation delay time Tpi corresponding to a transmission distance Li and a maximum propagation time Tpmax corresponding to the maximum applied distance Lmax:
2Tpi+Tg+Tdi=2Tpmax+Tg Eq.(1)
=constant value
where Tg is a protection time.
Disconnection Failure of Optical Fiber
On the other hand, when a disconnection failure of an optical fiber occurs in all of the above-mentioned transmission systems, i.e. the identical wavelength single-core bidirectional optical transmission system, a disconnection point has been detected by using a measuring device called an OTDR (Optical Time Domain Reflectometer).

Namely, in order to accurately detect the disconnection point of the optical fiber, the OTDR has received a Fresnel reflected light and a back-scattered light of a measuring optical pulse, and has performed an integration operation to be displayed on a display.

These methods are superior in accurately detecting failure points. However, an optical connector has to be switched over to be connected to a contact of an optical fiber termination frame where a failure has occurred, or the measuring device has to be connected through an optical splitter and an optical switch in the same way as an already-known optical line maintenance support system.

Therefore, upon switching over the optical connector, it is necessary to specify the contact of the optical fiber where a failure has occurred from numerous optical termination contacts to be connected to the measuring device. Therefore, there are defects that numerous operations are required, and human errors of wrongly connecting the measuring device to a normal optical fiber can not be avoided completely.

Also, there is a defect that huge equipment is required for connecting the measuring device through the optical splitter and the optical switch.

Furthermore, for the conventional disconnection point detection of the optical fiber, a wavelength specific to measurement different from a wavelength for transmitting information has been required to be used, and the integration of a measuring function into an optical transmission/reception circuit has been difficult because of an enlarged circuit scale.

Also, the conventional optical fiber disconnection point-detecting operation is started by manually connecting the measuring device at the optical fiber termination frame based on instructions by an operator upon a failure occurrence, or by connecting the measuring device by controlling the optical switch based on instructions from an operation support system. In either case, an operator's intervention has been necessary.

Also, in the identical wavelength one-to-many connection type optical branch-bidirectional optical transmission system, as for a trunk fiber from the intra-office transmission circuit to the optical branch device, the disconnection point can be detected by using the OTDR. However, as for the disconnection point detection on a branch fiber connected from the optical branch device to each user's house, it has been difficult to specify on which branch fiber a failure has occurred, since a test optical pulse is branched to have multiple echoes returned.

Furthermore, the optical transmission device and the measuring device for detecting optical fiber disconnection point have been completely different, and no integrated device thereof has existed conventionally.

### SUMMARY OF THE INVENTION

It is accordingly an object of the present invention to provide an optical transmission method and system for performing a bidirectional optical transmission at an identical wavelength between an intra-office transmission circuit and an in-house transmission circuit with a single-core optical fiber, where a disconnection failure of an optical fiber can be automatically detected without connecting a specific measuring device.

In the present invention, a failure point detection of an optical fiber, only for the detection of the disconnection point, is realized by switching over the operation of the intra-office transmission circuit from a normal operation to a disconnection point-detecting operation for measuring a time from a transmission of an isolated pulse for measuring optical fiber disconnection point to a reception thereof.

Therefore, an optical transmission method according to the present invention comprises: a first step for the intra-office transmission circuit to detect, based on a response failure of the in-house transmission circuits, an in-house transmission circuit corresponding to the response failure; and a second step for the intra-office transmission circuit to detect a failure point by transmitting an optical isolated pulse to the in-house transmission circuit corresponding to the response failure.

Namely, upon occurrence of a failure of disconnecting e.g. an optical fiber which is a transmission medium, the in-house transmission circuit can not respond even if it tries. Therefore, the intra-office transmission circuit can not receive an up signal from the in-house transmission circuit.

In such a case, in the conventional technology, an alarm of the response failure has been generated by the intra-office transmission circuit, and a measuring device called an OTDR has been brought before an optical fiber termination frame based on instructions of an operator, so that an optical fiber where a failure is supposed to have occurred has been accessed by switching over an optical connector and a measurement has been performed.

Also, upon connecting the measuring device through an optical splitter and an optical switch, the operation of the optical switch has been performed from an operation support system and the measurement for detecting a disconnection point has been performed.

On the contrary, in the present invention, when a response failure from the in-house transmission circuit has occurred, the intra-office transmission circuit detects the response failure (at the first step), and a normal operation is automatically switched over to a failure point detecting operation, and an optical isolated pulse is transmitted to the in-house transmission circuit according to the response failure, thereby enabling a distance to the failure point to be measured (at the second step).

Thus, in the present invention, when the disconnection failure of the optical fiber occurs in the single-core identical wavelength bidirectional transmission system, the detection of the disconnection point within the transmission circuit can be performed without using the OTDR. Therefore, the switchover of the optical connector and the connection of the measuring device become unnecessary, a measuring operation can be reduced, and a human error of wrongly connecting the measuring device to a normal optical fiber can be avoided. Also, huge equipment for connecting the measuring device through the optical splitter and the optical switch becomes unnecessary.

Furthermore, a wavelength specific to measuring becomes unnecessary for detecting the optical fiber disconnection point, so that a wavelength for transmitting information can be used, thereby enabling a measuring function to be integrated into the optical transmission/reception circuit by a slight increase of the circuit scale.

When the intra-office transmission circuit and the in-house transmission circuit are in a one-to-one connection relationship as shown in FIGS. 7 and 9 in the above-mentioned case, when the intra-office transmission circuit detects the response failure of the in-house transmission circuit at the first step, a failure point is detected by transmitting the optical isolated pulse to the in-house transmission circuit at the second step.

On the other hand, in a one-to-many connection type optical branch-bidirectional optical transmission system, when the intra-office transmission circuit and the in-house transmission circuits are connected in a one-to-many relationship as shown in FIG. 11, the intra-office transmission circuit may transmit the optical isolated pulse to a transmission line within a predetermined operation guarantee time to detect a failure point at the second step when detecting the response failure in one of the in-house transmission circuits at the first step.

Namely, the intra-office transmission circuit transmits the optical isolated pulse to each in-house ONU within a time guaranteeing operations of all of the in-house ONUs from a transmission of the burst signal 1112 shown in FIGS. 12 and 13 at the intra-office OLT until its return, and detects a failure point.

This will be more specifically described. When a response failure occurs in a certain optical fiber that is a transmission medium, all of the in-house transmission circuits ONUs can not perform communications even if they try, upon disconnection of the intra-office trunk fiber of the optical branch device, so that a state is brought about in which the up burst signals from the in-house ONUs can not be received even if they try, as observed from the intra-office OLT.

Also, upon a failure on a branch fiber, a state in which the up burst signal (information time slot from the concerned in-house ONU) from the concerned in-house ONU can not be received is brought about. Accordingly, upon disconnection of the branch fiber, an alarm is generated by the intra-office OLT as a reception frame synchronization loss, no reception of time slot from the concerned ONU or the like.

In the conventional technology, if this state occurs, the measuring device called the OTDR has been brought before the optical fiber termination frame based on the instructions of the operator, so that the optical fiber where a failure is supposed to have occurred has been accessed by switching over the optical connector and a measurement has been performed. Also, upon connecting the measuring device through the optical splitter and the optical switch, the operation of the optical switch has been performed from the operation support system and the measurement for detecting the disconnection point has been performed.

However, as mentioned above, in this method, as for a trunk fiber from the intra-office transmission circuit to the optical branch device, the disconnection point can be detected by using the OTDR. However, as for the detection of the disconnection point on a branch fiber connected from the optical branch device to each user's house, it has been difficult to specify on which branch fiber a failure has occurred, since a test optical pulse is branched to have multiple echoes returned.

In the present invention, when a failure of disconnecting an optical fiber occurs, the operation of the intra-office optical transmission termination circuit is automatically switched over from a normal operation to a disconnection point-detecting operation, thereby enabling a distance to the disconnection point to be measured within the intra-office optical transmission termination circuit.

In the single-core identical wavelength one-to-many connection type optical branch-bidirectional optical transmission system according to the present invention, an optical fiber disconnection point can be detected without exerting an influence on the operations of the ONUs accommodated in the branch fibers except the branch fiber where a failure has occurred in case of a disconnection failure of the branch fiber.

Also, when a response failure occurs, the result is notified to the operation support system. The operation support system having received the notification instructs the intra-office transmission circuit to switch over the intra-office transmission circuit from the normal operation to the disconnection point-detecting operation, thereby enabling a distance to the response failure point within the intra-office transmission circuit to be measured.

Accordingly, since the present invention has means autonomously notifying the detection result of the optical fiber disconnection point to the operation support system from the optical transmission device which has detected a failure, operator involvement becomes unnecessary upon failure occurrence.

A system for realizing the above-mentioned optical transmission method according to the present invention is presented, in which the intra-office transmission circuit detects, based on a response failure of the in-house transmission circuits, an in-house transmission circuit corresponding to the response failure, and detects a failure point by transmitting an optical isolated pulse to the in-house transmission circuit corresponding to the response failure.

In the above-mentioned one-to-many connection type optical branch-bidirectional optical transmission system, when the intra-office transmission circuit and the in-house transmission circuits are connected in a one-to-many relationship and when the intra-office transmission circuit detects the response failure in one of the in-house transmission circuits, the intra-office transmission circuit may transmit the optical isolated pulse to a transmission line within a predetermined operation guarantee time to detect a failure point.

Also, in the above-mentioned system, when detecting the response failure, the intra-office transmission circuit may notify a result thereof to an operation support system, and may detect the failure point when instructions for switching over from a normal operation to a disconnection point-detecting operation are received from the operation support system.

Furthermore, the present invention provides a transmission circuit in an intra-office for performing a bidirectional optical transmission at an identical wavelength with in-house transmission circuits with a single-core optical fiber, which comprises: first means detecting, based on a response failure of the in-house transmission circuits, an in-house transmission circuit corresponding to the response failure; and second means detecting a failure point by transmitting an optical isolated pulse to the in-house transmission circuit corresponding to the response failure.

In the transmission circuit of the above-mentioned one-to-many connection type optical branch-bidirectional optical transmission system, when the intra-office transmission circuit and the in-house transmission circuits are connected in a one-to-many relationship, and when the first means detect the response failure in one of the in-house transmission circuits, the second means may detect a failure point by transmitting the optical isolated pulse to a transmission line within a predetermined operation guarantee time.

Also, in the above-mentioned transmission circuit, when detecting the response failure, the first means may notify a result thereof to an operation support system, and the second means may detect the failure point when instructions for switching over from a normal operation to a disconnection point-detecting operation are received from the operation support system.

Furthermore, in the above-mentioned method, system and transmission circuit, the bidirectional optical transmission may be performed by a time compression multiplexing or an echo canceller system.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an embodiment of an intra-office transmission circuit according to the present invention;

FIG. 2 is a block diagram showing a connection relationship between an intra-office transmission device and an operation support system;

FIG. 3 is a diagram showing an embodiment of a telegram notifying an optical fiber disconnection point detection result transmitted from an intra-office transmission device to an operation support system by the present invention;

FIG. 4 is a diagram illustrating an optical isolated pulse between an intra-office side and a disconnection point upon disconnection of an optical fiber in an optical transmission system (one-to-one connection type) according to the present invention;

FIG. 5 is a block diagram showing another embodiment (echo canceller system) of an intra-office transmission circuit according to the present invention;

FIG. 6 is a diagram illustrating an operation of an optical isolated pulse transmitted upon disconnection of an optical fiber by an optical transmission system (one-to-many connection type) according to the present invention;

FIG. 7 is a block diagram of a single-core identical wavelength time compression one-to-one connection type bidirectional optical transmission system conventionally known;

FIG. 8 is a diagram illustrating an operation of a single burst cycle during a normal operation in the single-core identical wavelength time compression multiplexing-bidirectional optical transmission system shown in FIG. 7;

FIG. 9 is a block diagram of an echo canceller-bidirectional optical transmission system conventionally known;

FIG. 10 is a diagram illustrating a training operation in an intra-office transmission circuit of the echo canceller-bidirectional optical transmission system shown in FIG. 9;

FIG. 11 is a block diagram of a single-core identical wavelength time compression one-to-many connection type optical branch-bidirectional optical transmission system conventionally known;

FIG. 12 is a diagram illustrating an operation upon measuring a delay time of a newly established ONU in a single-core identical wavelength time compression one-to-many connection type optical branch-bidirectional optical transmission system conventionally known;

FIG. 13 is a diagram illustrating a time compression operation in a single-core identical wavelength time compression one-to-many connection type optical branch-bidirectional optical transmission system conventionally known;

FIG. 14 is a diagram illustrating an operation of a single burst cycle during a normal operation in a single-core identical wavelength time compression one-to-many connection type optical branch-bidirectional optical transmission system conventionally known; and

FIG. 15 is a diagram illustrating a delay time adjustment operation at each ONU during a normal operation in a single-core identical wavelength time compression one-to-many connection type optical branch-bidirectional optical transmission system conventionally known.

### DESCRIPTION OF THE EMBODIMENTS

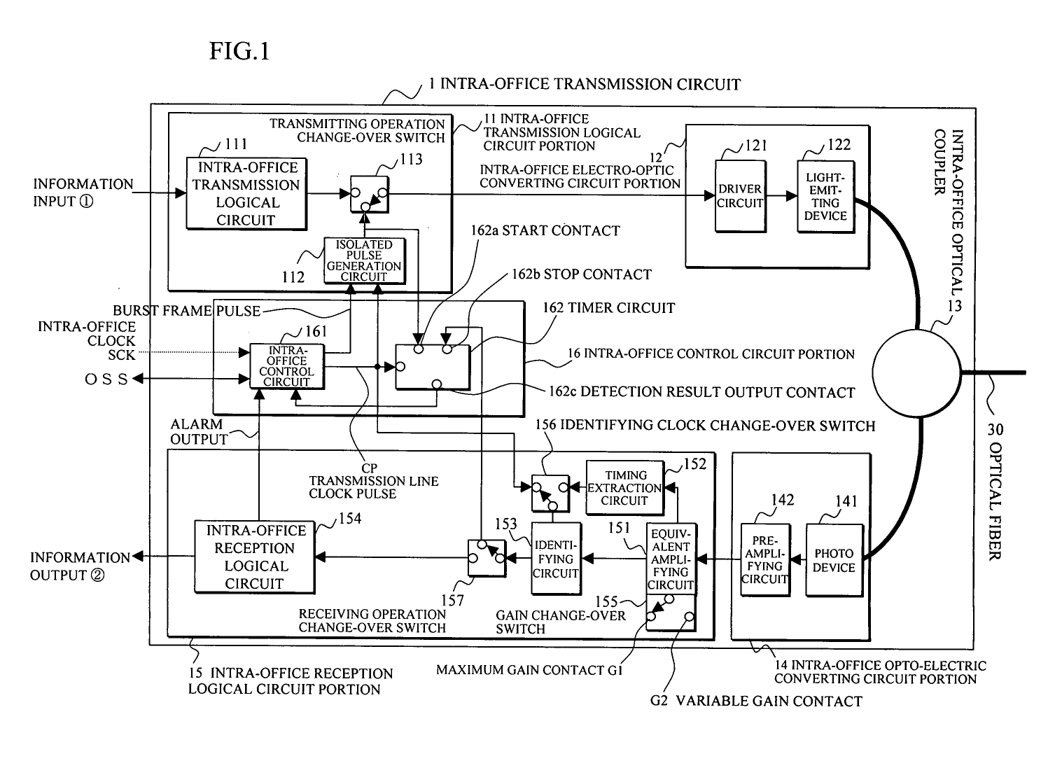

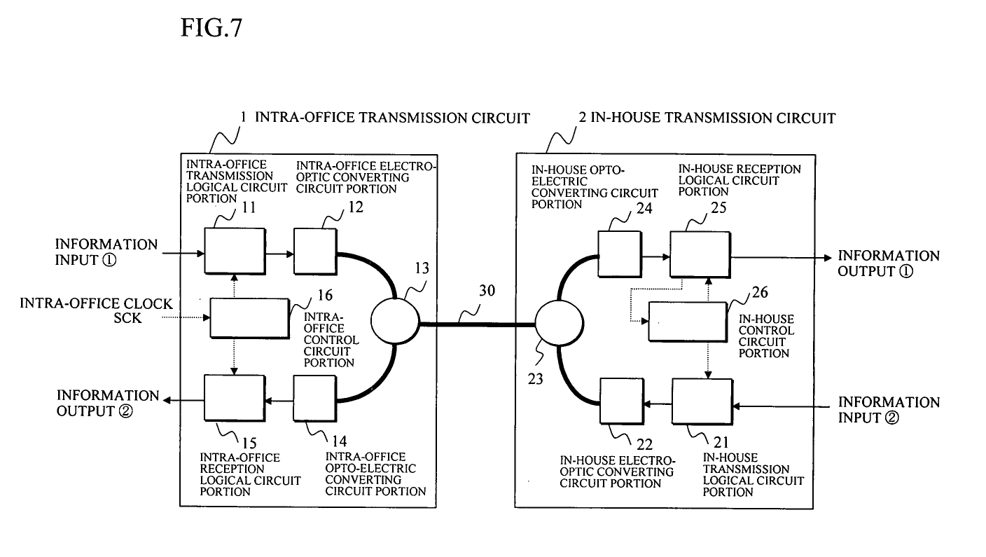

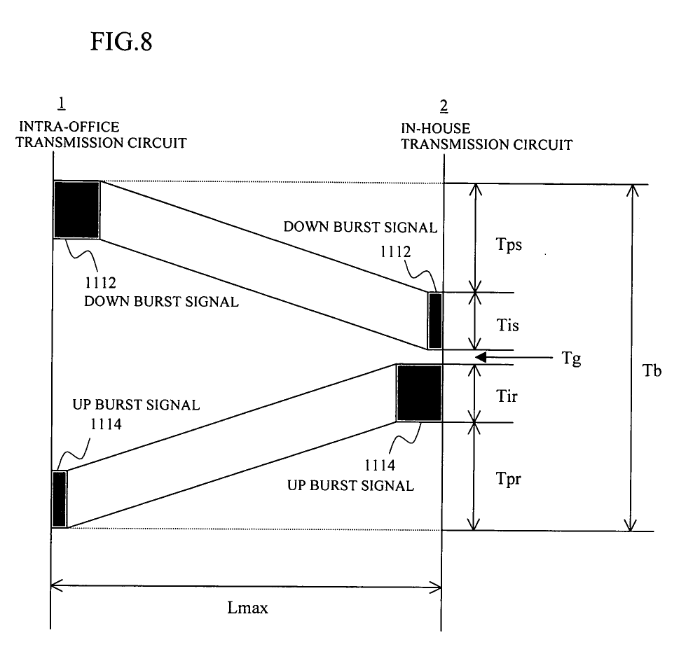

Single-core Identical Wavelength Bidirectional Transmission System (one-to-one Connection: FIGS. 1 and 7)

FIG. 1 shows an embodiment of an intra-office transmission circuit by a single-core identical wavelength time compression multiplexing-bidirectional optical transmission system according to the present invention. This embodiment has a feature that the intra-office transmission logical circuit portion 11 in the prior art example of FIG. 7 is composed of an intra-office transmission logical circuit 111, an isolated pulse generation circuit 112 and a transmitting operation change-over switch 113. The intra-office control circuit portion 16 is composed of an intra-office control circuit 161 and a timer circuit 162. The intra-office reception logical circuit portion 15 is composed of an equivalent amplifying circuit 151, a timing extraction circuit 152, an identifying circuit 153, an intra-office reception logical circuit 154, a gain change-over switch 155, an identifying clock change-over switch 156 and a receiving operation change-over switch 157.

It is to be noted that the intra-office electro-optic converting circuit portion 12 is composed of a driver circuit 121 and a light-emitting device 122, and the intra-office opto-electric converting circuit portion 14 is composed of a photo device 141 and a pre-amplifying circuit 142, in the same way as the above-mentioned prior art example.

Hereinafter, the operation of this embodiment will be described.

When the intra-office transmission circuit 1 is normally operated, the switches 113, 115-157 are located on the opposite side to those in FIG. 1. Namely, the intra-office transmission logical circuit 111 is connected to the intra-office electro-optic converting circuit portion 12, the switch 155 is connected to a variable gain contact G2, the timing extraction circuit 152 is connected to the identifying circuit 153, and the identifying circuit 153 is connected to the intra-office reception logical circuit 154.

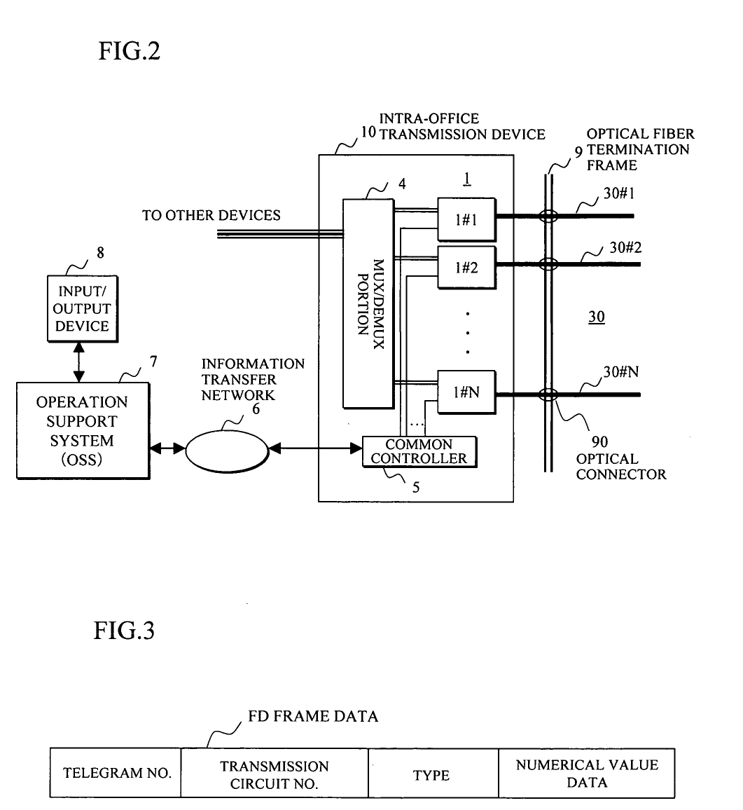

FIG. 2 shows a connection relationship between an intra-office transmission device 10 and an operation support system 7. Generally, a single intra-office transmission device 10 has a plurality of intra-office transmission circuits 1 shown in FIG. 1 corresponding to users. As for information transmitted, N units of intra-office transmission circuits 1#1-1#N are connected to other devices through a MUX/DEMUX (multiplexing/demultiplexing) portion 4.

Alarms from the intra-office transmission circuits 1#1-1#N and a setting control to the intra-office transmission circuits 1 are combined by a common controller 5 of the intra-office transmission device 10, and communication with the operation support system (OSS) 7 is performed through an information transfer network 6 composed of a LAN or the like.

Generally, the communication between the operation support system and the transmission device is performed in a form of a packet telegram of contents as shown in FIG. 3.

The operation support system 7 has an input/output device 8 controlling a human machine interface with an operator. A personal computer or workstation is generally used for the input/output device 8. Optical fibers 30#1-30#N from the intra-office transmission circuits 1 are connected to the optical fiber extending to a user's house by an optical fiber termination frame 9 with an optical connector 90, where a failure inside the office is isolated from a failure outside the office.

It is needless to say that in order to make the detection of the disconnection point more reliable, a light-emitting power of the optical isolated pulse transmitted from the intra-office transmission circuit may be made equal to or more than twice as much as a light-emitting power during the normal operation. Also, it is needless to say that in order to accurately obtain the distance to the disconnection point, measurements may be performed a plurality of times and the operation of averaging the values may be performed.

When a disconnection state of the reception signal is detected by the intra-office reception logical circuit 154, an alarm is transmitted to the operation support system 7 from the intra-office control circuit 161 through the common controller 5 of the intra-office transmission device 10. The operator of the operation support system 7 instructs the concerned intra-office transmission circuit 1 to switch from the normal operation over to the disconnection point-detecting operation based on the alarm.

The intra-office control circuit 161 switches over, upon receiving instructions from the operation support system 7, the transmitting operation change-over switch 113, the gain change-over switch 155, the identifying clock change-over switch 156 and the receiving operation change-over switch 157 to a detecting operation mode of the disconnection point.

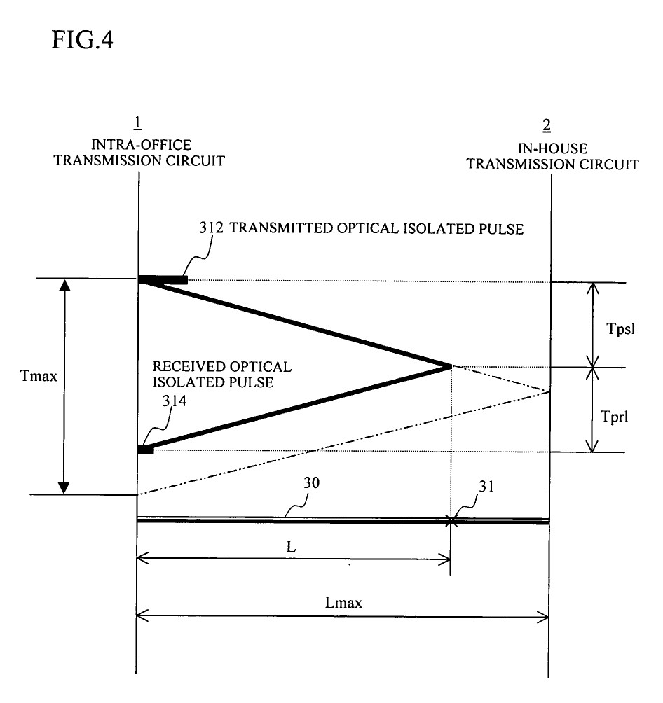

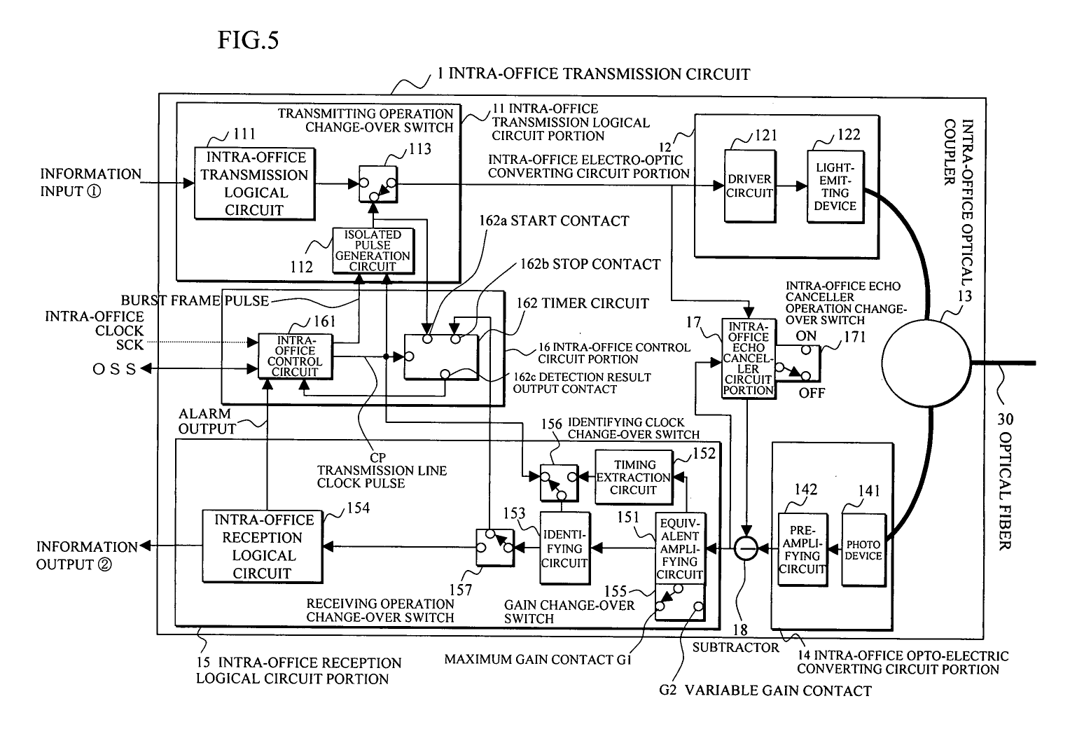

When the operation of the intra-office transmission circuit 1 is switched over to the disconnection point-detecting operation, the intra-office transmission logical circuit portion 11 generates an isolated pulse at a longer cycle than a propagation time (Tmax) of an optical signal corresponding to a distance twice as long as the maximum applied distance (Lmax) as shown in FIG. 4. The isolated pulse becomes an optical isolated pulse 312 by the intra-office electro-optic converting circuit portion 12 to be transmitted to the optical fiber 30 through the intra-office optical coupler 13.

As shown in FIG. 4, the optical isolated pulse 312 attenuates due to a loss of light to be propagated within the optical fiber 30 from the intra-office transmission circuit to the in-house transmission circuit, and is almost completely reflected at a disconnection point 31 of the optical fiber to be returned to the intra-office transmission circuit. A reflected optical isolated pulse 314 received through the intra-office optical coupler 13 is converted into an electric signal by the intra-office opto-electric converting circuit portion 14 to be inputted to the intra-office reception logical circuit portion 15.

In the disconnection point-detecting operation, the intra-office reception logical circuit portion 15, different from the normal operation state, waits for the reflected optical isolated pulse 314 with an equivalent function among reproduction relaying functions (equivalent amplifying, timing extracting and identifying functions) being fixed to the maximum gain and with the identifying function being a normal threshold (normally 0.5).

In the intra-office control circuit portion 16, a timer for counting time is started at the time of the above-mentioned isolated pulse generation by the intra-office transmission logical circuit portion 11 and a timer circuit 162 is stopped at the time when the received reflected optical isolated pulse 314 is determined to exist by the identifying function.

If the value of this timer is divided by 2, and is further divided by a propagation delay time per unit distance of light within the optical fiber, a distance (L) from the intra-office transmission circuit to the disconnection point of the optical fiber can be obtained. This timer clock may be specific to a timer or a clock CP of the transmission line signal may be used as it is by a frequency division or multiplication.

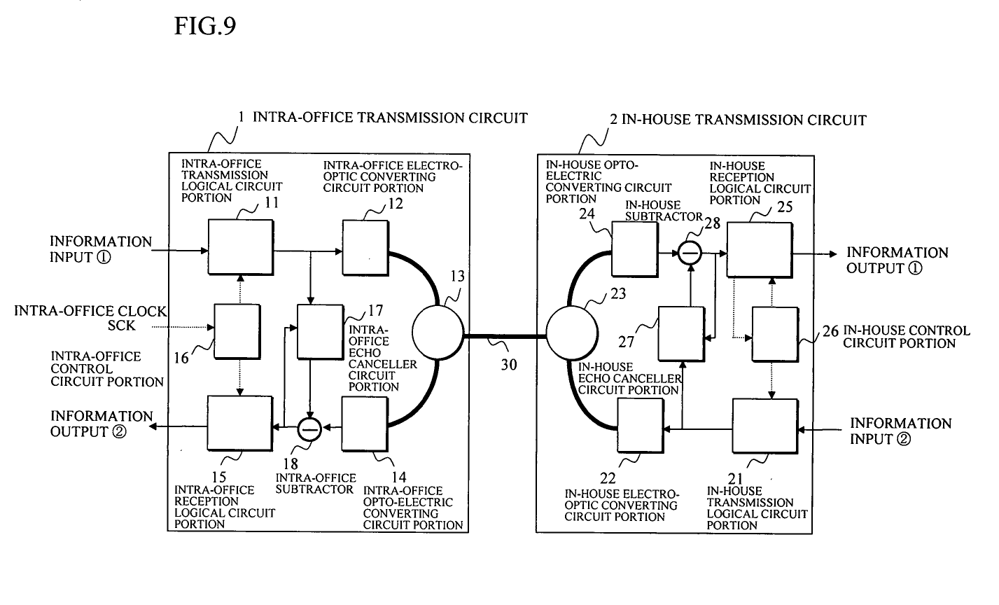

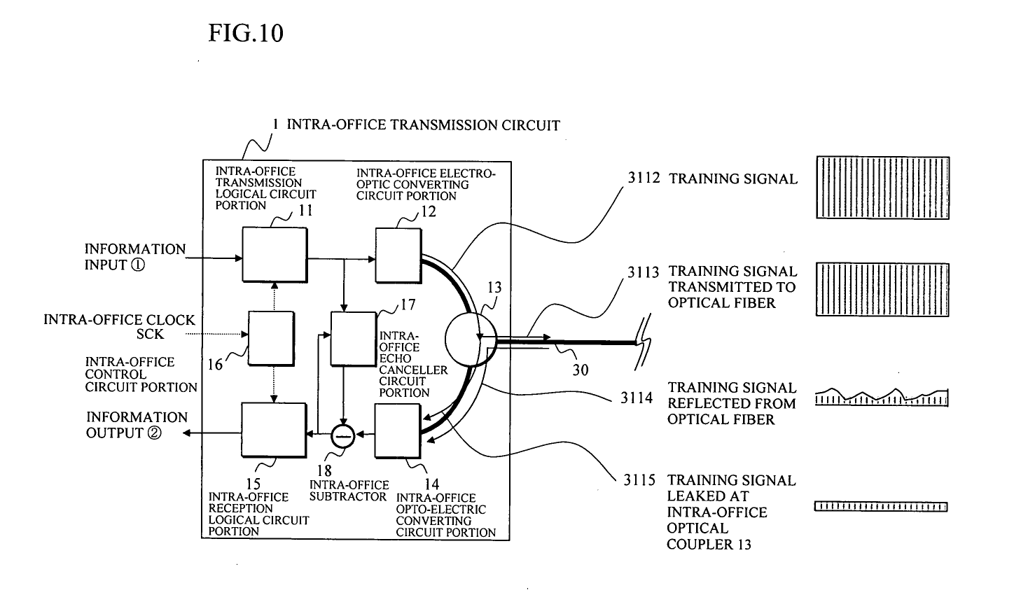

Echo Canceller-bidirectional Optical Transmission System (one-to-one Connection: FIGS. 5 and 9)

FIG. 5 shows an embodiment of an intra-office transmission circuit by an echo canceller-bidirectional optical transmission system according to the present invention.

This embodiment has a feature that the intra-office transmission logical circuit portion 11 in the prior art example of FIG. 9 is composed of the intra-office transmission logical circuit 111, the isolated pulse generation circuit 112 and the transmitting operation change-over switch 113. The intra-office control circuit portion 16 is composed of the intra-office control circuit 161 and the timer circuit 162. The intra-office reception logical circuit portion 15 is composed of the equivalent amplifying circuit 151, the timing extraction circuit 152, the identifying circuit 153, the intra-office reception logical circuit 154, the gain change-over switch 155, the identifying clock change-over switch 156 and the receiving operation change-over switch 157. An intra-office echo canceller operation change-over switch 171 is added to the intra-office echo canceller circuit portion 17.

It is to be noted that the intra-office electro-optic converting circuit portion 12 is composed of the driver circuit 121 and the light-emitting device 122, and the intra-office opto-electric converting circuit portion 14 is composed of the photo device 141 and the pre-amplifying circuit 142, in the same way as the prior art example.

Hereinafter, operation of this embodiment will be described.

The disconnection point-detecting operation in the intra-office transmission circuit 1 will now be described in detail by referring to FIG. 5 and the above-mentioned FIG. 4. In FIG. 5, the transmitting operation change-over switch 113, the gain change-over switch 155, the identifying clock change-over switch 156, the receiving operation change-over switch 157 and the intra-office echo canceller operation change-over switch 171 are switched over to the detecting operation mode of the disconnection point, and the switches are supposed to be switched over to the opposite side in the normal operation mode.

Namely, when the disconnection of the reception signal is detected by the intra-office reception logical circuit 154, an alarm is transmitted from the intra-office control circuit 161 to the operation support system 7 through the common controller 5 of the intra-office transmission device 10. The operator of the operation support system OSS instructs the concerned intra-office transmission circuit 1 to switch over from the normal operation to the disconnection point-detecting operation as shown based on the alarm.

The intra-office control circuit 161 switches over, upon receiving instructions from the operation support system 7, the transmitting operation change-over switch 113, the gain change-over switch 155, the identifying clock change-over switch 156, the receiving operation change-over switch 157 and the intra-office echo canceller operation change-over switch 171 to the detecting operation mode of the disconnection point.

The isolated pulse generation circuit 112 generates a disconnection point detecting isolated pulse from an isolated pulse repetition cycle pulse and a transmission line clock pulse CP to be transmitted to the driver circuit 121 and the intra-office echo canceller circuit portion 17 through the transmitting operation change-over switch 113, and the isolated pulse is also transmitted to a start contact of the timer circuit 162.

Since the intra-office echo canceller operation change-over switch 171 is OFF in the disconnection point-detecting operation, the intra-office echo canceller circuit portion 17 stops an operation including a training. The driver circuit 121 drives the light-emitting device 122 with the isolated pulse to be converted into the optical isolated pulse, which is transmitted to the optical fiber 30 through the intra-office optical coupler 13.

As shown in FIG. 4, since there is no burst cycle in the echo canceller-bidirectional optical transmission system different from the time compression multiplexing-bidirectional optical transmission system, the isolated pulse may be transmitted with a cycle more than twice (Tmax) as long as the propagation time of the maximum applied distance (Lmax). In FIG. 4, the transmitted optical isolated pulse 312 is completely reflected at the disconnection point 31 of the optical fiber 30 to form the received optical isolated pulse 314.

Namely, the optical isolated pulse 314 reflected at the disconnection point 31 of the optical fiber enters the photo device 141 through the intra-office optical coupler 13 to be taken out as an electric signal by the pre-amplifying circuit 142. This electric signal is added to the intra-office subtractor 18. Since the operation of the intra-office echo canceller circuit portion 17 is stopped, the electric signal added is amplified by the equivalent amplifying circuit 151 as it is to be added to the identifying circuit 153.

If the equivalent amplifying circuit 151 has a fixed gain, there is no problem. However, since an AGC (Automatic Gain Control) normally operates, the gain of the equivalent amplifying circuit 151 is fixed to the maximum gain by the gain change-over switch 155 in the detecting operation mode of the disconnection point.

Also, while the clock extracted from the reception signal by the timing extraction circuit 152 is used as the clock of the identifying circuit 153 in the normal operation mode, the identifying clock change-over switch 156 is switched over and the transmission line clock on the transmitting side is used in the detecting operation mode of the disconnection point.

It is needless to say that in order to reliably identify the received optical isolated pulse 314 by the transmission line clock on the transmission side, a time width of the optical isolated pulse 312 transmitted may be made equal to or more than twice as much as a reciprocal of a transmission line clock frequency.

If the received isolated pulse 314 is identified by the identifying circuit 153, an identifying output is added to a stop contact of the timer circuit 162 through the receiving operation change-over switch 157. The timer circuit 162 starts the measurement when the pulse is added to the start contact, and stops the measurement when the pulse is added to the stop contact.

It is needless to say that in order to prevent the detecting operation of disconnection points from being made unstable by the transmitted optical isolated pulse 312 coming into the reception side, the pulse added to the start contact of the timer circuit 162 may be delayed or the switchover of the receiving operation change-over switch 157 which transmits the identifying output to the stop contact of the timer circuit 162 may be delayed.

A value of ½ of the measured time value is transmitted to the intra-office control circuit 161 from the detection result output contact of the timer circuit 162, and is further transmitted to the operation support system 7 through the common controller 5 of the intra-office transmission device 10. The operator arranges a failure repair of the optical fiber based on the detection result of the optical fiber disconnection point.

While it is supposed in this description that the value of ½ of the measured time value is read from the detection result output contact of the timer circuit 162, the measured value of the timer itself may be used as a value. It is needless to say that conversion processing into the distance to the disconnection point of the optical fiber may be performed by the intra-office control circuit 161, the common controller 5 of the intra-office transmission device 10 or the operation support system 7.

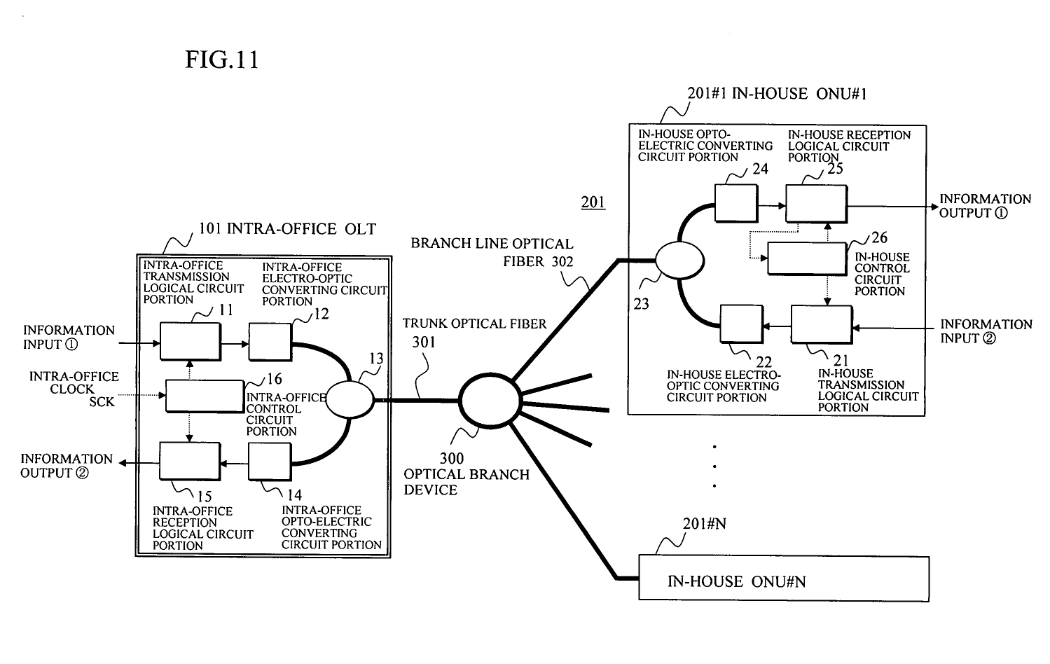

Single-core Identical Wavelength Time Compression Multiplexing-bidirectional Optical Transmission System (one-to-many Connection: see FIGS. 1 and 11)

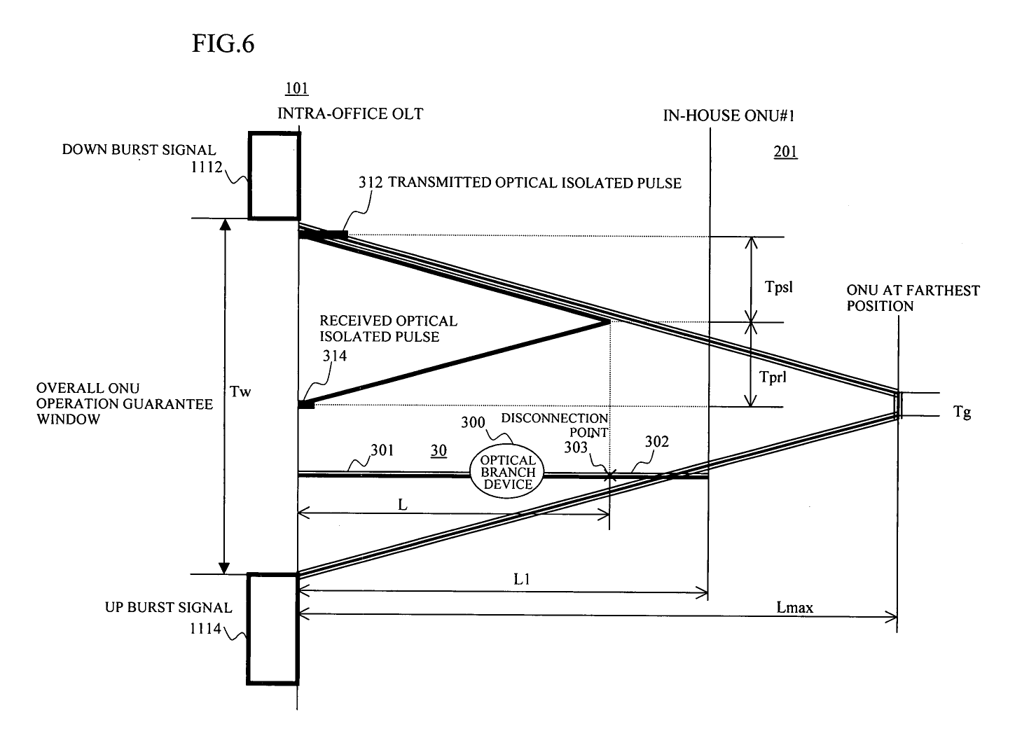

Hereinafter, an example in a case where a disconnection failure of the optical fiber occurs in the branch fiber 302 when a transmission circuit of FIG. 1 is applied to the single-core identical wavelength time compression one-to-many connection type optical branch-bidirectional optical transmission system shown in FIG. 11 will be described referring to FIG. 6. It is to be noted that the echo canceller system of FIG. 5 is not applied in the same way as a prior art.

In this case, a time window Tw for guaranteeing the operation of the in-house ONU 201 at the farthest position is provided in consideration of the transmission distance (propagation delay time) between each ONU 201 and the OLT 101.

As shown in FIG. 6, an overall ONU operation guarantee window Tw requires a time more than the propagation delay time for a distance twice as long as the farthest distance (Lmax) plus the protection time (Tg).

Namely, an up signal disconnection from the specific ONU 201 is detected within the received burst signal 1114 of the intra-office OLT 101, the fiber disconnection at the branch fiber 302 is determined, so that the operation of the intra-office transmitter/receiver is switched over from the normal operation to the disconnection point-detecting operation. At this time, the optical isolated pulse 312 is generated at the starting point of the overall ONU operation guarantee window Tw to be transmitted to the optical fiber 301 toward all of the in-house ONUs through the intra-office optical coupler 13.

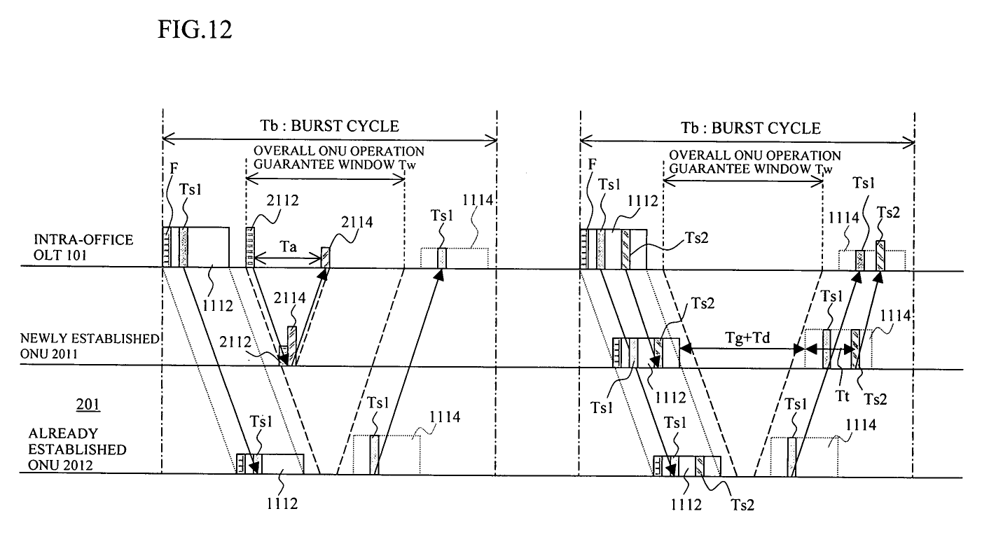

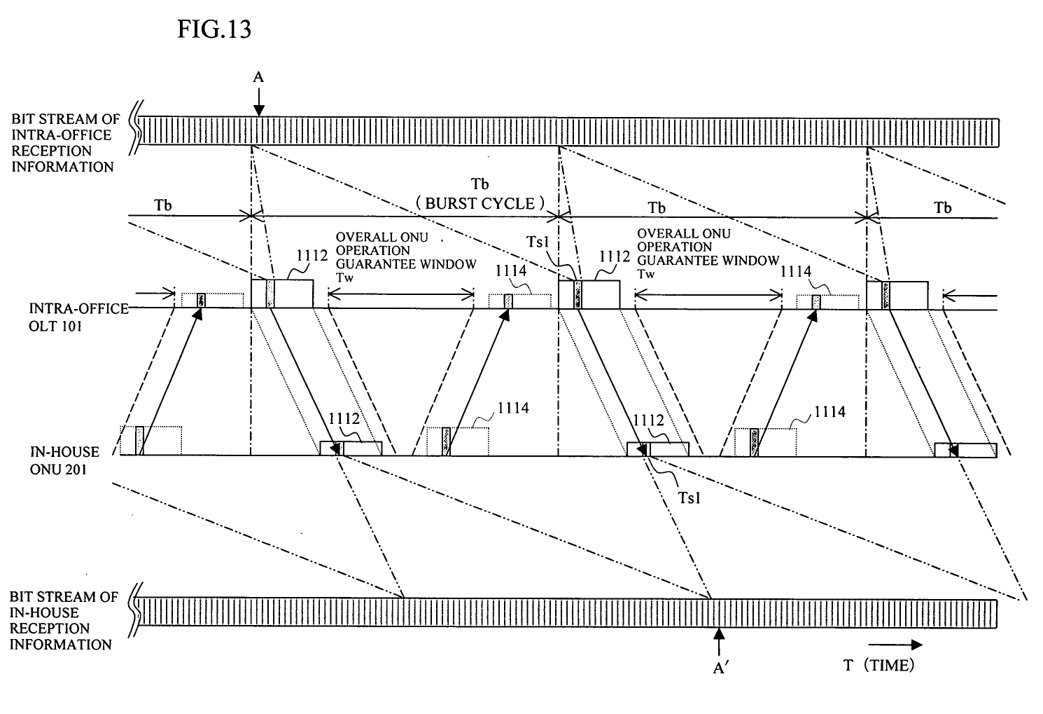

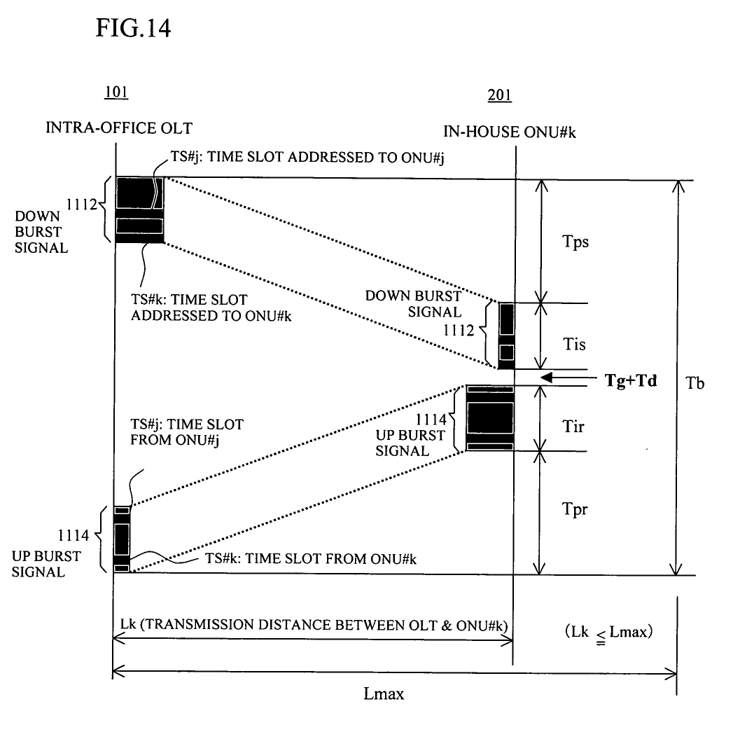

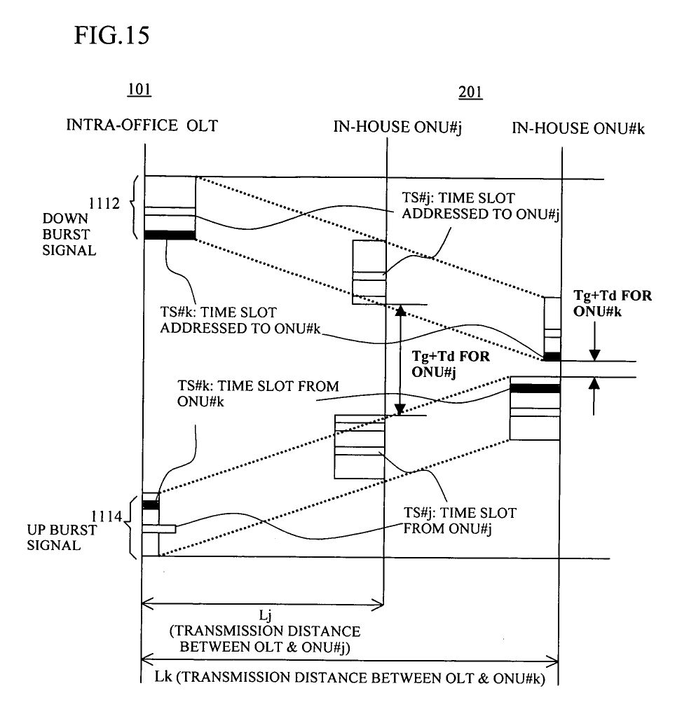

Namely, in the isolated pulse generation circuit 112, a burst frame pulse F shown in FIG. 12 and the disconnection point detecting isolated pulse from the transmission line clock pulse of the bit stream shown in FIG. 13 are generated and transmitted to the driver circuit 121 through the transmitting operation change-over switch 113. Also, the isolated pulse is transmitted to the start contact 162a of the timer circuit 162.

The driver circuit 121 drives the light-emitting device 122 with the isolated pulse to be converted into the optical isolated pulse. The optical isolated pulse is transmitted to the optical fiber 30 through the intra-office optical coupler 13.

As shown in FIG. 6, the transmitted optical isolated pulse 312 is completely reflected at e.g. a disconnection point 303 (when a support fiber 302 exists) of the optical fiber 30 to be returned to the intra-office reception logical circuit portion 15 through the intra-office optical coupler 13 as the received optical isolated pulse 314. The intra-office reception logical circuit portion 15, different from the normal operation state, waits for the reflected optical isolated pulse with an equivalent function among reproduction relaying functions (equivalent amplifying, timing extracting and identifying functions) being fixed to the maximum gain and with the identifying function being a normal threshold (normally 0.5). Namely, the optical isolated pulse enters the photo device 141 to be taken out as an electric signal by the pre-amplifying circuit 142. This electric signal is amplified by the equivalent amplifying circuit 151 to be added to the identifying circuit 153.

If the equivalent amplifying circuit 151 has a fixed gain, there is no problem. However, the AGC (Automatic Gain Control) normally operates, the gain of the equivalent amplifying circuit 151 is fixed to the maximum gain at the gain change-over switch 155 in the detecting operation mode of the disconnection point.

Also, while the clock extracted from the reception signal by the timing extraction circuit 152 is used as the clock of the identifying circuit 153 in the normal operation mode, the identifying clock change-over switch 156 is switched over and the transmission line clock CP on the transmitting side is used in the detecting operation mode of the disconnection point.

In order to reliably identify the received isolated pulse by the transmission line clock CP on the transmission side, the time width (connection time) of the isolated pulse transmitted may be made equal to or more than twice as much as the reciprocal of the transmission line clock frequency.

If the received isolated pulse is identified by the identifying circuit 153, the identifying output is added to a stop contact 162b of the timer circuit 162 through the receiving operation change-over switch 157. The timer circuit 162 starts the measurement when the pulse is added to a start contact 162a, and stops the measurement when the pulse is added to the stop contact 162b.

In order to prevent the detecting operation of disconnection points from being made unstable by the transmitted optical isolated pulse 312 coming into the reception side, the pulse added to the start contact 162a of the timer circuit 162 may be delayed or the switchover timing of the receiving operation change-over switch 157 which transmits the identifying output of the identifying circuit 153 to the stop contact 162b of the timer circuit 162 may be delayed.

The value of ½ of the measured time value is transmitted to the intra-office control circuit 161 from the detection result output contact 162c of the timer circuit 162, and is further transmitted to the operation support system 7 through the common controller 5 of the intra-office transmission device 10.

If the value of this timer is divided by 2, and is further divided by the propagation delay time per unit distance of light within the optical fiber, the distance (L) from the intra-office transmission circuit to the disconnection point 303 of the optical fiber 30 can be obtained. This timer clock may be specific to the timer or the clock of the transmission line signal may be used as it is, or by the frequency division or multiplication. The operator arranges a failure repair of the optical fiber 30 based on the detection result of the optical fiber disconnection point.

While it is supposed in this description that the value of ½ of the measured time value is read from the detection result output contact 162c of the timer circuit 162, the measured value of the timer itself may be used as the value, and it is needless to say that conversion processing into the distance to the disconnection point 303 of the optical fiber 30 may be performed by the intra-office control circuit 161, the common controller 5 of the intra-office transmission device 10 or the operation support system 7.

While it is supposed in the above-mentioned embodiment that the switchover control of the operation of the intra-office transmission circuit 1 from the normal operation to the disconnection point-detecting operation is performed manually from outside or from the operation support system 7, it may be automatically performed within the intra-office transmission circuit 1.

Namely, when an alarm output of transmission signal disconnection is received from the intra-office reception logical circuit 154, the intra-office control circuit 161 of the intra-office transmission circuit 1 automatically switches over from the normal operation to the above-mentioned identical disconnection point-detecting operation.

The distance to the disconnection point is measured within the timer circuit 162, the result thereof is transmitted to the common controller 5 of the intra-office transmission device 10, and the operation is switched back to the normal operation. Furthermore, the common controller 5 of the intra-office transmission device 10 autonomously notifies intra-office transmission circuit Nos. (1#1-1#N) having detected the failure and numerical values of the measurement result to the operation support system 7 in the form of a packet telegram.

FIG. 3 shows an embodiment of the packet telegram, where “telegram No.” indicates an identifier for specifying a telegram between the intra-office transmission device and the operation support system, and “transmission circuit No.” indicates an identifier of a physical location generally composed of “building name, floor, frame No., unit No., shelf No., a package No., interface No.” and the like.

Also, “type” indicates a type, i.e. a major alarm such as LOS (Loss Of Signal) and LOF (Loss Of Frame), performance information such as bit error, or information such as a detection result of an optical fiber disconnection point followed by numerical value data. “Numerical value data” indicate data of a specific numerical value such as the number of bit errors and a detection result numerical value of the optical fiber disconnection point.

The operation support system 7 specifies a user's house from user data and a transmission circuit No. of a database held, distance data to the failure point is matched with a route diagram of the optical fiber cable to specify the failure point.

It is to be noted that while the intra-office OLT 101 transmits the burst signal 1112 and receives the up burst signal 1114, the mode is switched over to the normal operation mode, and only during the period of the overall ONU operation guarantee window Tw, the mode can be switched over to the detecting operation mode of the disconnection point.

Also, since the optical isolated pulse used for the failure point detection is within the operation guarantee window Tw, other ONUs in which no branch fiber disconnection occurs are not influenced by the disconnection point-detecting operation, so that the normal service operation is not prevented.

Also, the common controller 5 of the intra-office transmission device 10 autonomously notifies the intra-office transmission circuit No. having detected the failure and the numerical value of the measurement result to the operation support system in the form of the packet telegram. The embodiment of the packet telegram is the same as that shown in FIG. 3 except that the ONU No. is added to the end of the transmission circuit No.

As described above, the present invention has an advantage of detecting a disconnection point of an optical fiber without using an expensive measuring device. Also, it is neither necessary to access by switching over an optical connector of a termination contact of an optical fiber where a failure has occurred to the measurement device, nor to connect the measuring device through an optical splitter and an optical switch.

Therefore, there are advantages that upon switching over the optical connector, numerous operations for specifying an optical fiber contact where a failure has occurred from among numerous optical termination contacts and for connecting the measuring device become unnecessary, and human errors of wrongly connecting the measuring device to a normal optical fiber can be avoided.

Also, there is an advantage that a huge equipment becomes unnecessary for connecting the measuring device through the optical splitter and the optical switch.

Furthermore, there are advantages that using a wavelength specific to the measurement different from the wavelength for transmitting information like the optical fiber disconnection point detection in the conventional technology is unnecessary, and the disconnection point of the optical fiber can be detected only with the wavelength for transmitting the information.

Since the measurement function is realized by switching over the operation of the intra-office transmission circuit of the single-core identical wavelength bidirectional optical transmission system, there is an advantage that a cost increase by the function addition is minimal. Also, there is an advantage that functions can be integrated into a conventional optical transmission/reception module since an increase of a circuit scale is little.

Furthermore, there is an advantage that in the one-to-many connection type optical branch-bidirectional optical transmission system, a branch fiber failure disconnection point can be detected without exerting an influence upon other users during a current service, by diverting the delay measuring function provided in the PON transmission system.

There is an advantage that an operator's operation can be greatly reduced since the disconnection failure of the optical fiber is detected by the transmission signal disconnection, and the intra-office transmission circuit can autonomously transmit the switchover detection result to the operation support system.

1. An optical transmission method for performing a bidirectional optical transmission at an identical wavelength between an intra-office transmission circuit and in-house transmission circuits with a single-core optical fiber comprising:
a first step for the intra-office transmission circuit to detect, based on a response failure of the in-house transmission circuits, an in-house transmission circuit corresponding to the response failure; and
a second step for the intra-office transmission circuit to detect a failure point by transmitting an optical isolated pulse to the in-house transmission circuit corresponding to the response failure.

2. The optical transmission method as claimed in claim 1, wherein when the intra-office transmission circuit and the in-house transmission circuits are connected in a one-to-many relationship in a one-to-many connection type optical branch-bidirectional optical transmission system, the intra-office transmission circuit transmits the optical isolated pulse to a transmission line within a predetermined operation guarantee time to detect a failure point at the second step when detecting the response failure in one of the in-house transmission circuits at the first step.

3. The optical transmission method as claimed in claim 1, wherein when detecting the response failure at the first step, the intra-office transmission circuit notifies a result thereof to an operation support system, and executes the second step when instructions for switching over from a normal operation to a disconnection point-detecting operation are received from the operation support system.

4. The optical transmission method as claimed in claim 1, wherein the bidirectional optical transmission is performed by a time compression multiplexing or an echo canceller system.

5. An optical transmission system comprising:
an intra-office transmission circuit; and
in-house transmission circuits;
the intra-office transmission circuit performing a bidirectional optical transmission at an identical wavelength with the in-house transmission circuits with a single-core optical fiber, detecting, based on a response failure of the in-house transmission circuits, an in-house transmission circuit corresponding to the response failure, and detecting a failure point by transmitting an optical isolated pulse to the in-house transmission circuit corresponding to the response failure.

6. The optical transmission system as claimed in claim 5, wherein when the intra-office transmission circuit and the in-house transmission circuits are connected in a one-to-many relationship in a one-to-many connection type optical branch-bidirectional optical transmission system, the intra-office transmission circuit detects the response failure in one of the in-house transmission circuits and transmits the optical isolated pulse to a transmission line within a predetermined operation guarantee time to detect a failure point.

7. The optical transmission system as claimed in claim 5, wherein when detecting the response failure, the intra-office transmission circuit notifies a result thereof to an operation support system, and detects the failure point when instructions for switching over from a normal operation to a disconnection point-detecting operation are received from the operation support system.

8. The optical transmission system as claimed in claim 5, wherein the bidirectional optical transmission is performed by a time compression multiplexing or an echo canceller system.

9. A transmission circuit in an intra-office for performing a bidirectional optical transmission at an identical wavelength with in-house transmission circuits with a single-core optical fiber comprising:
first means detecting, based on a response failure of the in-house transmission circuits, an in-house transmission circuit corresponding to the response failure; and
second means detecting a failure point by transmitting an optical isolated pulse to the in-house transmission circuit corresponding to the response failure.

10. The transmission circuit as claimed in claim 9, wherein when the intra-office transmission circuit and the in-house transmission circuits are connected in a one-to-many relationship in a one-to-many connection type optical branch-bidirectional optical transmission system, the first means detect the response failure in one of the in-house transmission circuits, and the second means detect a failure point by transmitting the optical isolated pulse to a transmission line within a predetermined operation guarantee time.

11. The transmission circuit as claimed in claim 9, wherein when detecting the response failure, the first means notify a result thereof to an operation support system, and the second means detect the failure point when instructions for switching over from a normal operation to a disconnection point-detecting operation are received from the operation support system.

12. The transmission circuit as claimed in claim 9, wherein the bidirectional optical transmission is performed by a time compression multiplexing or an echo canceller system.

13. The optical transmission method as claimed in claim 2, wherein when detecting the response failure at the first step, the intra-office transmission circuit notifies a result thereof to an operation support system, and executes the second step when instructions for switching over from a normal operation to a disconnection point-detecting operation are received from the operation support system.

14. The optical transmission system as claimed in claim 6, wherein when detecting the response failure, the intra-office transmission circuit notifies a result thereof to an operation support system, and detects the failure point when instructions for switching over from a normal operation to a disconnection point-detecting operation are received from the operation support system.

15. The transmission circuit as claimed in claim 10, wherein when detecting the response failure, the first means notify a result thereof to an operation support system, and the second means detect the failure point when instructions for switching over from a normal operation to a disconnection point-detecting operation are received from the operation support system.
